(19) United States
(12) Patent Application Publication
(10) Pub. No.: US 2006/0065764 A1
(43) Pub. Date: Mar. 30, 2006

(54) Substrate processing showerheads

(76) Inventor: Ole Schlottmann, Cardiff (GB)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/231,830

(22) Filed: Sep. 22, 2005

Related U.S. Application Data
(60) Provisional application No. 60/612,507, filed on Sep. 24, 2004.

(51) Int. Cl. B05B 1/14

(52) U.S. Cl. 239/557

(57) ABSTRACT

A sheet (200) adapted for fitting in a substrate processing showerhead (100), the sheet including a plurality of orifices (208, 210), wherein boundaries of at least some of the orifices (208) are substantially surrounded by an upstanding wall (212) formed of deformable material.

The present application claims priority from U.S. Provisional application Ser. No. 60/612,507 filed on Sep. 24^{th}, 2004.

### FIELD OF THE INVENTION

The present invention relates to showerheads for substrate processing.

### BACKGROUND TO THE INVENTION

An example of part of a conventional showerhead 100 is illustrated in FIG. 1. The showerhead comprises a disc-shaped faceplate 101 and a backing plate 102. Orifices 104 are formed through the faceplate. A volume 106 between the faceplate and the backing plate acts as a gas reservoir to allow conduction of gas from inside the showerhead through the faceplate orifices 104 to a processing space 108.

A seal 110 is provided between parts 112 of the backing plate 102 that project down to the faceplate 101. The seal 110 conventionally comprises a disc-shaped sheet of elastomer material having orifices formed in it that correspond to the locations of the orifices 104 in the faceplate. Such elastomer materials are relatively expensive and if a mistake occurs when drilling the orifices then the sheet will be wasted. Forming the orifices in the elastomer sheet also tends to produce particles and oil haze, which are potentially damaging to process and/or substrate. Further, sealing sheets formed of elastomeric materials such as silicon can react with gases in the showerhead and interfere with the processing of the substrate.

### SUMMARY OF THE INVENTION

According to a first aspect of the present invention there is provided a sheet adapted for fitting in a substrate processing showerhead, the sheet including a plurality of orifices, wherein boundaries of at least some of the orifices are substantially surrounded by an upstanding wall formed of deformable material.

In use, the sheet may be fitted between two components of the showerhead such that at least some of the walls are deformed (by force transmitted through at least one of the components), with the deformed material substantially sealing the two components.

A depressed area may be formed generally around an orifice location in which a wall may be formed between the depressed area and the boundary of the orifice. In such a depressed area, the distance between a lower surface of the sheet and an (exposed) upper surface of the sheet within the depressed area is less than the distance between the lower surface of the sheet and a normal upper surface of the sheet.

In some embodiments, the orifice locations may be arranged in at least one substantially straight line on the surface of the sheet and the upstanding walls may be formed around the locations of alternate orifices in a said line.

The orifices and/or depressed areas may have generally circular boundaries. The diameter of at least one orifice may be around 0.05 mm, whilst the diameter of its associated depressed area may be around 0.15 mm.

The deformable material may be non-elastic and can be a metal such as aluminium. Advantages provided by using such a material include the fact that it is cheaper than an elastomer; there can also be less risk of it reacting with other substances commonly used in gas showerheads and interfering with the process and the thermal conduction is better than that provided by an elastomer seal.

In some embodiments, the boundaries are formed to surround at least some of the orifices on both sides of the sheet.

According to a further aspect of the present invention there is provided a substrate processing showerhead including:
a gas inlet leading to a gas reservoir;
a faceplate fitted between the reservoir and a processing space, the faceplate including a plurality of orifices, and
a seal fitted between the faceplate and another component of the showerhead, the seal including a sheet having a plurality of orifices, wherein boundaries of at least some of the orifices are substantially surrounded by an upstanding wall formed of deformable material.

According to a further aspect of the present invention there is provided a method of manufacturing a seal adapted for use in a substrate processing showerhead, the method including steps of:
providing a sheet including a plurality of orifices, and
forming upstanding walls of deformable material that substantially surround boundaries of at least some of the orifices.

The step of forming the upstanding wall may include forming a depressed area (e.g. by photo-etching) around a location of a said orifice, thereby creating an upstanding wall between the depressed area and the orifice boundary. The depressed area may be formed as a substantially ring-shaped depression generally surrounding an orifice location, wherein an inner diameter of the ring has a diameter greater than a diameter of the orifice.

According to a further aspect of the present invention there is provided a method of assembling a substrate processing showerhead, the method including steps of:
fitting a sheet between components of the showerhead, the sheet having a plurality of orifices, wherein boundaries of at least some of the orifices are substantially surrounded by an upstanding wall formed of deformable material, and
forcing at least one of the components onto the sheet such that at least some of the orifice-surrounding walls are deformed, with the deformed material substantially sealing the two components.

Whilst the invention has been described above, it extends to any inventive combination of the features set out above or in the following description.

### BRIEF DESCRIPTION OF THE DRAWINGS

The invention may be performed in various ways, and, by way of example only, an embodiment thereof will now be described, reference being made to the accompanying drawings, in which:—

FIG. 1 illustrates schematically a cross-section through part of a conventional showerhead;

FIG. 2 illustrates a portion of a sheet according to one embodiment of the invention;

FIG. 3 illustrates a portion of a showerhead fitted with the sheet;

FIG. 4 details some of the components shown in FIG. 3, and

FIG. 5 illustrates a portion of a sheet according to another embodiment featuring a double-sided arrangement.

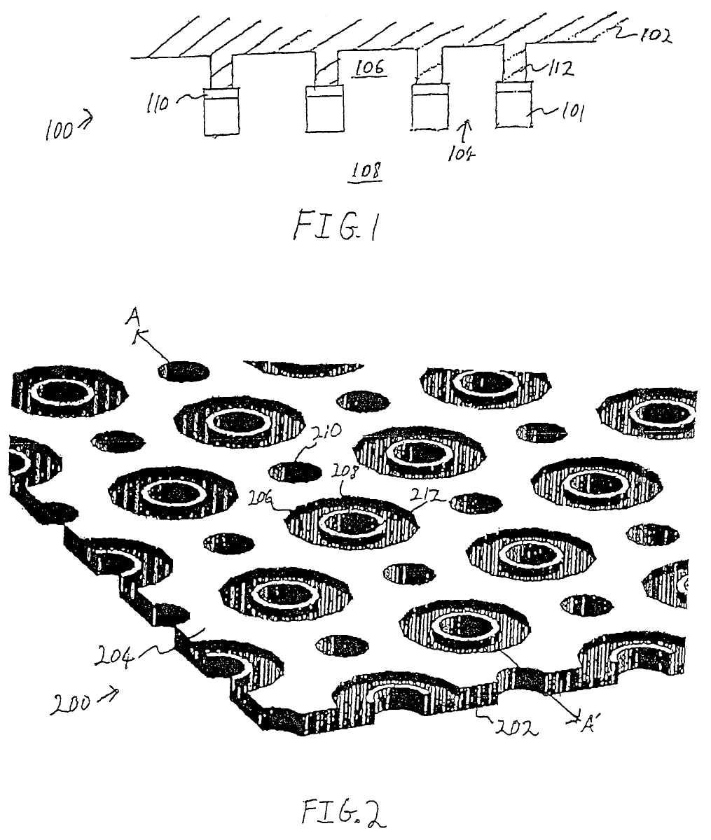

### DETAILED DESCRIPTION OF THE DRAWINGS

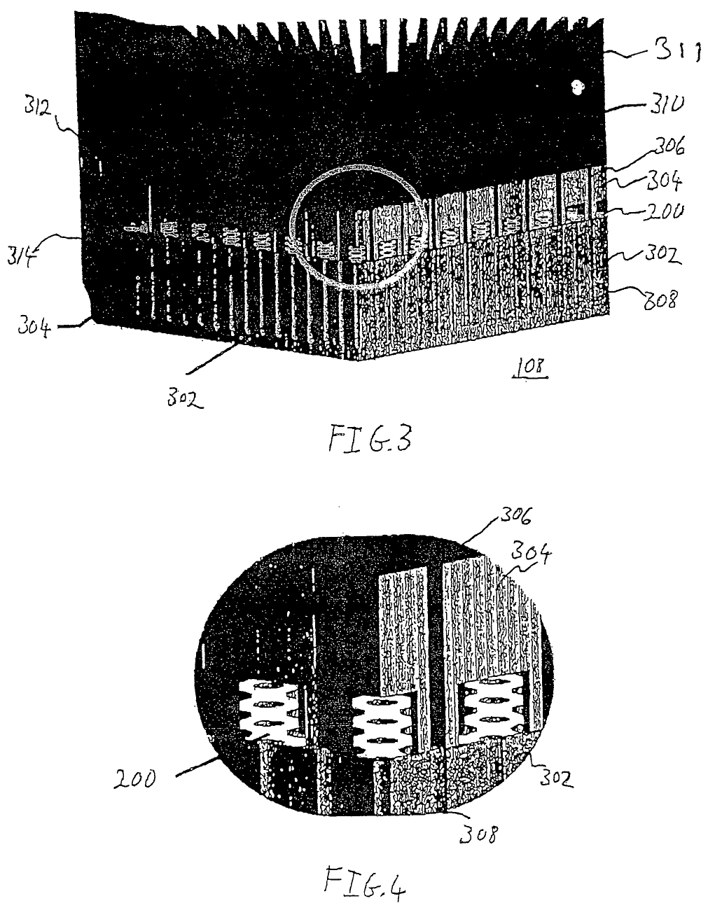

FIG. 2 shows a sheet 200 of aluminium having a thickness (i.e. the distance between its lower surface 202 and its upper surface 204 before any features are formed on the sheet) of around 0.15 mm. Other deformable materials may also be used for the sheet 200, preferably ones that do not react with the type of substances with which the showerhead is to be used. A plurality of ring-shaped depressed areas 206 are formed on the upper surface of the sheet 200. The depressed areas 206 can be formed using photo-etching or any other suitable process. The outer diameter of the ring is around 5.0 mm and its inner diameter is around 2.5 mm. The depth of the depressed area (i.e. the distance from the normal upper surface 204 of the sheet down to the exposed surface within the depressed area) is around 0.05 mm.

The depressed areas are formed in a series of notional straight lines over the upper surface of the sheet 200. One such line is denoted by line A-A′ in FIG. 2. The distance between the centre of one depressed area and the centre of the next depressed area in the line is about 10 mm. After the depressed areas have been formed in this way, a circular area of sheet material (of normal sheet height) lies within the inner diameter of the ring shape.

A plurality of orifices are then formed through the sheet 200. The orifices can be formed by laser drilling or any other suitable process. The orifices are formed in substantially the same series of notional straight lines as the depressed areas 206, but the distance between the centre of one orifice and the centre of the next orifice in the line is around 10 mm. Thus, there will normally be twice as many orifices in each line as there are depressed areas. The centres of alternate orifices 208 in each line coincide with the centres of the circular areas within the depressed areas 206 of that line and the interleaving orifices 210 in the line are positioned in the non-depressed areas between adjacent depressed areas.

The diameter of each of the orifices is around 0.05 mm, which is less than the diameter of the circular area that was present within the depressed area 206 and so there is effectively a circular wall 212 having a thickness of around 0.25 mm left upstanding from the exposed upper surface of each depressed area 206 that substantially surrounds the perimeter/boundary of each orifice 208.

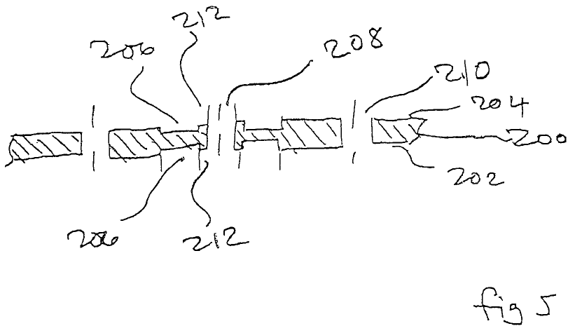

Turning to FIGS. 3 and 4, it can be seen that in use the sheet 200 can be fitted between a faceplate 302 of a showerhead and another component 304 of the showerhead. In the example shown in the Figures, the other component comprises a dividing/baffle plate 304, which is a generally disc-shaped piece of metal having a plurality of orifices 306 drilled through it. In the example, the baffle plate orifices 306 are aligned with at least some of the orifices 308 formed in the faceplate 302. Fitted behind the upper surface of the baffle plate 304 is a backing plate 310 with a heat sink component 311 on its outer face. The volume 312 between the lower surface of the backing plate 310 and the upper surface of the baffle plate 304 can receive a first gas via an inlet (not shown) and the volume 314 between the lower surface of the baffle plate and the upper surface of the mesh can receive a second (different) gas via another inlet. These two gases should normally not be mixed until they have entered the process volume 108.

As can best be seen in FIG. 4, the boundaries of the baffle plate orifices 306 are substantially aligned with the boundaries of the sheet orifices 208 that are surrounded by the walls 212 (but not the other orifices 210) and the orifices 308 of the underlying faceplate 302. The diameter of each baffle plate orifice can have a similar diameter (or a slightly smaller diameter) as the sheet orifices 208, 210. When the baffle plate 304 is fitted in the showerhead, it is forced down onto the sheet 200. This causes the walls 214 to deform to a certain extent (which may only be on a nano- or microscopic level), which effectively creates a metal-to-metal seal between the faceplate 302 and the baffle plate 304. This seal is sufficient to prevent the first gas passing down from the upper reservoir 312 through the baffle plate orifices 306 from escaping into the lower reservoir 314. As the two gases in the showerhead are often at the same pressure, contact sealing can be sufficient to keep them apart. The seal formed is also effective in preventing the second gas in the lower reservoir 314 (that is intended to pass down through the other sheet orifices 210) from mixing with the first gas before entering the process volume 108.

Little or no particles are created as a result of this deformation. Further, surface imperfections will normally be present in components such as the lower face of the baffle plate 304 and the deformed material can effectively act as a type of shim to reduce wear that may occur due to friction taking place between rigid surfaces of the showerhead components.

It will be appreciated that if the diameter of the baffle plate orifices 306 was slightly greater than the diameter of the walls 212 then the walls 212 could slidably fit inside the baffle plate orifices. If the two diameters were sufficiently close then a seal could also be formed in this way; however, this would require precise alignment of the baffle plate 304 and the sheet 200.

It will be understood that the showerhead shown in the Figures is exemplary only and that the sheet 200 can be fitted between a different set of showerhead components. For example, in some showerheads the baffle plate 304 may not be present and parts of the showerhead backing plate may lie on top of the sheet 200. Further, there may be a sheet of material (as described in the present applicant's published specification number US-2004-0123800-A1) fitted adjacent the faceplate 302 and/or the showerhead component on the other side of the sheet 200. The sheet 200 could be positioned next to any such components and still function as a seal as described herein. The sheet walls can still be deformed even if the components directly abutting them (on either or both sides) are not rigid, provided that there is sufficient force being transferred through the abutting components from other rigid components when the showerhead is being assembled. Also, at least some of the sheet orifices 208,210 can have a diameter smaller than the diameter of the orifices leading to the process space 108 and so can effectively control the conduction of gas to the process space.

It will be appreciated that although the orifices in the sheet 200 and the showerhead components are shown as being circular and generally arranged in straight lines in the example, other shapes and patterns of orifices could be used, although drilling circular apertures in an array of straight lines is currently the most convenient way of forming such orifices. Also, the wall 212 need not completely surround an orifice 208, e.g. it could be intermittent, provided that the wall is formed of a sufficient amount of material to create the seal when it is deformed. It will be also understood that the distribution of the depressed areas on the sheet could be varied. Further, some of the orifices in the sheet and/or other components of the showerhead could be blocked to provide a desired distribution of gas (e.g. to avoid a “bulls eye” effect).

The walls 212 could also be formed by first drilling the orifices 208 and then forming the depressed areas 206. It will be also appreciated that upstanding walls substantially surrounding the boundaries of orifices on a sheet can be formed in ways other than by creating the orifice-surrounding depressed areas that define the walls. For example, a sheet of deformable non-elastic material such as Aluminium having “lips”/walls upstanding around the boundaries of at least some of its orifices could be moulded, or small rings of deformable non-elastic material could be attached to a pre-formed sheet having a plurality of orifices.

The dimensions given above are exemplary only. Holes cut using current laser cutting technology may typically have diameters down to around 0.05 mm. For a 0.05 mm diameter hole, the outer ring diameter may be around 0.15 mm. Also, the sheet may be thinner than the 0.15 mm sheet thickness example mentioned above and the depth of the depressed areas may be selected as any depth necessary to form a suitable sealing ring wall 212. A practical diameter for the depression 204 is 3.0 mm using current manufacturing techniques.

It will be further understood features identical or similar to those described above on a single face of a sheet may also be formed on both faces of a sheet, as shown in FIG. 5. This can help the sheet seal against components fitted adjacent both of its faces. The features on one of the faces of the sheet may have different dimensions (e.g. the diameter of the orifices 208, the diameter and/or depth of the depressed areas, the height of the walls 212) to the features on the other face.

We claim:

1. A sheet adapted for fitting in a substrate processing showerhead, the sheet including a plurality of orifices, wherein boundaries of at least some of the orifices are substantially surrounded by an upstanding wall formed of deformable material.

2. A sheet according to claim 1, where, in use, the sheet is fitted between two components of the showerhead such that at least some of the walls are deformed by force transmitted through at least one of the components, with the deformed material substantially sealing the two components.

3. A sheet according to claim 1, wherein a depressed area is formed generally an orifice location in which a said wall is formed between the depressed area and the boundary of the orifice.

4. A sheet according to claim 1, wherein the orifice locations are arranged in at least one substantially straight line (A-A′) on a surface of the sheet and the walls are formed around the locations of alternate orifices in a said line.

5. A sheet according to claim 3, wherein the boundaries of the orifices and/or the depressed areas are generally circular.

6. A sheet according to claim 1, wherein the diameter of a said orifice is around 0.05 mm.

7. A sheet according to claim 3, wherein the diameter of a said depressed area is around 0.15 mm.

8. A sheet according to claim 1, wherein the deformable non-elastic material comprises a metal such as aluminium.

9. A sheet according to claim 1, wherein the walls are formed to surround at least some of the orifices on both sides of the sheet.

10. A substrate processing showerhead including:
a gas inlet leading to a gas reservoir;
a faceplate fitted between the reservoir and a processing space, the faceplate including a plurality of orifices, and
a seal fitted between the faceplate and another component of the showerhead, the seal including a sheet having a plurality of orifices, wherein boundaries of at least some of the orifices are substantially surrounded by an upstanding wall formed of deformable material.

11. A method of manufacturing a seal adapted for use in a substrate processing showerhead, the method including steps of:
providing a sheet including a plurality of orifices, and
forming upstanding walls of deformable material that substantially surround boundaries of at least some of the orifices.

12. A method according to claim 11, wherein the step of forming the upstanding wall includes forming a depressed area around a location of a said orifice, thereby creating the upstanding wall between the depressed area and the orifice boundary.

13. A method according to claim 12, wherein the depressed area is formed as a substantially ring-shaped depression generally surrounding a said orifice location, wherein an inner diameter of the ring has a diameter greater than a diameter of the orifice.

14. A method of assembling a substrate processing showerhead, the method including steps of:
fitting a sheet between components of the showerhead, the sheet having a plurality of orifices, wherein boundaries of at least some of the orifices are substantially surrounded by an upstanding wall formed of deformable material, and
forcing at least one of the components onto the sheet such that at least some of the orifice-surrounding walls are deformed, with the deformed material substantially sealing the two components.
